(19) United States
(12) Patent Application Publication
(10) Pub. No.: US 2015/0046128 A1
(43) Pub. Date: Feb. 12, 2015

(54) FILTRATION METHOD FOR ABNORMAL SENSING DATA OF MONITORING CHIP

(71) Applicants: Inventec Corporation, Taipei City (CN); Inventec (Pudong) Technology Corporation, Shanghai (CN)

(72) Inventor: Chun-Peng ZHOU, Shanghai (CN)

(73) Assignees: Inventec Corporation, Taipei City (TW); Inventec (Pudong) Technology Corporation, Shanghai (CN)

(21) Appl. No.: 14/076,281

(22) Filed: Nov. 11, 2013

(30) Foreign Application Priority Data
Aug. 9, 2013 (CN) 201310347157.7

(51) Int. Cl. G01K 1/00

(52) U.S. Cl. CPC G01K 1/00
USPC 702/190

(57) ABSTRACT

A filtration method for filtrating abnormal sensing data by a monitoring chip is disclosed. A sensing data is obtained by a sensor performing real-time monitoring of a sensed object. The monitoring chip receives the sensing data from the sensor every sensing time interval. When a duration of the monitoring chip receiving continuously a plurality of abnormal sensing data has reached a set duration, the monitoring chip puts to use a last received abnormal sensing data and provides an indication that the sensed object is operating abnormally. When the duration of the monitoring chip receiving continuously a plurality of abnormal sensing data has not reached the set duration, the monitoring chip puts to use the last received sensing data before receiving the plurality of abnormal sensing data without utilizing the plurality of abnormal sensing data.

### RELATED APPLICATIONS

This application claims priority to Chinese Application Serial Number 201310347157.7, filed Aug. 9, 2013, which is herein incorporated by reference.

### BACKGROUND

1. Field of Invention

The present invention relates to a filtration method. More particularly, the present invention relates to a filtration method for filtrating abnormal sensing data by a monitoring chip.

2. Description of Related Art

For a conventional electronic device (e.g., a computer), a serial communication bus (e.g., I²C) directly coupled to a power supply and a main system circuitry (e.g., motherboard) may be too lengthy, causing data to be interfered with by current or other factors during transmission. This may result in a change in the data being transmitted so that a monitoring chip receives abnormal sensing data, ultimately causing the monitoring chip to misinterpret the state of the power supply. Consequently, even though the power supply is functioning normally, the main system circuitry can be shut down automatically through implementation of a self-protection mechanism, thereby causing inconvenience.

Conventional monitoring chips merely receive data for transmitting signals to other system modules. Although a conventional monitoring chip can instruct a related system module to perform corresponding safeguard operations when abnormal data is received, the conventional monitoring chip is unable to determine the integrity of the received data. Therefore, an important area of research requiring improvement relates to controlling the monitoring chip to filter the received data to ensure stable operation of main system circuitry.

### SUMMARY

The present invention provides a filtration method for filtrating abnormal sensing data by a monitoring chip. The sensing data is obtained by a sensor sensing a sensed object in real-time. The monitoring chip receives the sensing data from the sensor every detection period. The filtration method comprises when a duration of the monitoring chip continuously receiving a plurality of abnormal sensing data has reached a set duration, utilizing a last received sensing data in the plurality of abnormal sensing data and providing an indication that the sensed object is abnormal; and when the duration of the monitoring chip continuously receiving the plurality of abnormal sensing data has not reached the set duration, utilizing a last received sensing data before receiving the plurality of abnormal sensing data without utilizing the plurality of abnormal sensing data.

In accordance with one embodiment of the present invention, the monitoring chip records recorded data corresponding to the sensor, and the recorded data is updated according to the sensing data.

In accordance with yet another embodiment of the present invention, utilizing the last received sensing data in the plurality of abnormal sensing data comprises utilizing the last received sensing data in the plurality of abnormal sensing data to update the recorded data.

In accordance with yet another embodiment of the present invention, utilizing the last received sensing data before receiving the plurality of abnormal sensing data comprises utilizing the last received sensing data before receiving the plurality of abnormal sensing data to be the recorded data.

In accordance with yet another embodiment of the present invention, when a difference between the sensing data the monitoring chip received from the sensor and the recorded data the monitoring chip recorded reaches a predetermined abnormal range, the sensing data is considered to be abnormal sensing data.

In accordance with yet another embodiment of the present invention, when the difference between the sensing data the monitoring chip received from the sensor and the recorded data the monitoring chip recorded does not reach the predetermined abnormal range, the sensing data is utilized to update the recorded data.

In accordance with yet another embodiment of the present invention, the monitoring chip is a baseboard management controller (BMC).

In accordance with yet another embodiment of the present invention, the sensor is a temperature sensor for sensing a temperature of the sensed object.

In accordance with yet another embodiment of the present invention, the temperature sensor is electrically connected to the monitoring chip.

In accordance with yet another embodiment of the present invention, the sensed object is a power controller.

In summary, techniques of the present invention contain obvious advantages and benefits as compared to conventional techniques. By utilizing techniques mentioned above, significant improvements as well as wide industrial application can be achieved. One advantage of the present invention is that the monitoring chip can perform filtration with respect to the data received, thereby enabling the main system circuitry to stably operate.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart illustrating a filtration method for filtrating abnormal sensing data by a monitoring chip according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

A monitoring chip in a device (e.g., a server)monitors variations of internal environmental factors of the device (e.g., temperature of a power supply during operation), and provides data so that hardware (e.g., a CPU) or firmware (e.g., BIOS) of the device can perform corresponding operations. If the variation of an internal environmental factor exceeds a threshold or a system component is malfunctioning, the monitoring chip records the abnormal event or data for future reference, and issues an alert to notify the device administrator. The monitoring chip can also activate a self-protection mechanism (e.g., a shut down mechanism) to prevent excessive variations of the internal environmental factor from damaging the device.

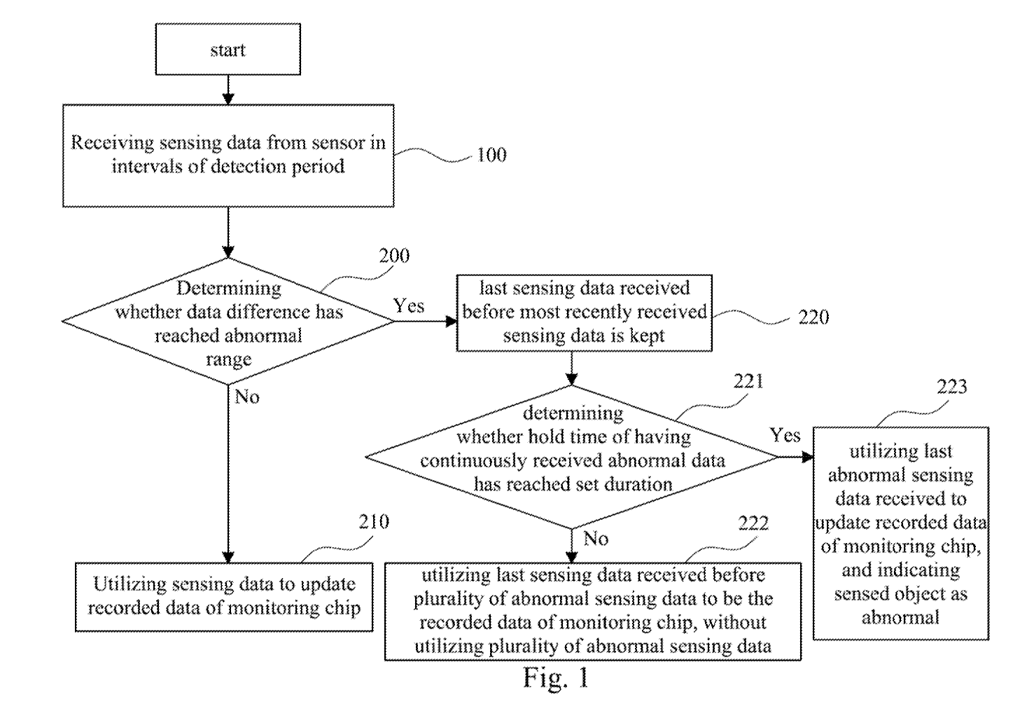

FIG. 1 is a flow chart illustrating a filtration method for filtrating abnormal sensing data by a monitoring chip according to an embodiment of the present invention. The monitoring chip of a device continuously receives sensing data from a sensor of the device, and monitors the received sensing data. As shown in step 100 of FIG. 1, the monitoring chip receives the sensing data from the sensor in intervals of a detection period (e.g., 1 second intervals). The administrator of the device can configure the detection period in the program of the sensor, such that the sensor transmits the sensing data to the monitoring chip every detection period Alternatively, the administrator of the device can also configure the detection period via a system program of the device.

When the sensing data is being transmitted to the monitoring chip, the sensing data may be interfered by factors such as current, electromagnetic noise, etc., so that the sensing data may be altered and cannot be correctly transmitted to the monitoring chip. When the monitoring chip has received the sensing data, the monitoring chip immediately calculates a data difference between the current sensing data and the previous sensing data. Under normal conditions, sensing data obtained by the monitoring chip at two adjacent detection points separated by the detection period does not show much variation. If the variation is significant, however, this may be caused by two conditions.

In a first condition, the sensing data is actually interfered by factors such as electromagnetic noise, causing the sensing data to be abnormal, In a second condition, the sensing data of the sensor accurately reflects an abnormal variation of the internal environment of the device. The second condition relates to the monitoring chip functioning in the way that it was intended. If the first condition is encountered, the monitoring chip may misinterpret the sensing data, so that abnormal sensing data may be recorded, and may even result in the device activating the self-protection mechanism, causing inconvenience to the device administrator. Hence, upon receiving the sensing data, the monitoring chip does not immediately update the recorded data of the monitoring chip according to the sensing data from the sensor. Instead, the monitoring chip calculates a difference between the sensing data and the corresponding recorded data upon receiving the sensing data, and then performs a determination accordingly.

In step 200, the monitoring chip calculates whether the difference between the sensing data the monitoring chip received from the sensor and the recorded data the monitoring chip recorded corresponding to when the sensing data is received has reached a predetermined abnormal range. The difference between the sensing data and the recorded data corresponding to when the sensing data is received is referred to as a data difference. When the data difference has reached the predetermined abnormal range, the device activates the self-protection mechanism to prevent excessive variation of the internal environmental factor from damaging the device. The device administrator can configure the abnormal range in the program of the monitoring chip. The device administrator can also configure the abnormal range via a system program of the device.

When the data difference has reached the predetermined abnormal range, it might not necessarily be due to excessive variation of the internal environmental factor. The sensing data may be distorted due to interference in the transmission, causing the data difference to reach the predetermined abnormal range. In order to determine the cause of the data difference reaching the abnormal range, in step 220, if the data difference between the sensing data the monitoring chip received from the sensor and the recorded data the monitoring chip recorded has reached the predetermined abnormal range, the last sensing data received before the most recently received sensing data is kept as the recorded data and the monitoring chip is temporarily considered to receive normal data same as the last sensing data received before the most recently received sensing data so that the sensed object is temporarily considered to work normally. The normal data is utilized as a reference to monitor subsequent sensing data received by the monitoring chip, so as to determine the cause of the data difference reaching the predetermined abnormal range. The device can then perform corresponding actions according to the determined cause.

Upon receiving the sensing data that causes the data difference to reach the predetermined abnormal range, the monitoring chip continues to receive a plurality of sensing data from the sensor. At this time, the monitoring chip utilizes the normal data as a reference to calculate the data difference between each of the plurality of subsequent sensing data and the normal data. Through such operation, a duration of the data difference being continuously reaching the predetermined abnormal range can be obtained. Such a duration can be referred to as a abnormal sensing data hold duration. A determination is then made as to whether the abnormal sensing data hold duration has exceeded a set duration. The administrator of the device can configure the set duration in the program of the sensor or the monitoring chip. Alternatively, the administrator of the device can configure the set duration via a system program of the device. The set duration corresponds to how long the device can tolerate abnormalities. In step 221, the monitoring chip determines whether the abnormal sensing data hold duration associated with a plurality of continuous abnormal sensing data has reached the set duration.

When the abnormal sensing data hold duration has not reached the set duration, the monitoring chip temporarily treats the plurality of abnormal sensing data as being caused by temporary interference of the environmental factor, or by the internal environment of the device being temporarily abnormal. The device can tolerate being abnormal for such a hold duration. In step 222, when the abnormal sensing data hold duration has not reached the set duration, the monitoring chip utilizes the last sensing data received before receiving the plurality of abnormal sensing data to be the recorded data of the monitoring chip, and does not utilize the plurality of abnormal sensing data.

In an embodiment of the present invention, when the abnormal sensing data hold duration has reached the set duration, the monitoring chip treats the plurality of abnormal sensing data as being caused by continuous interference of environmental interference factors, or by the internal environment of the device actually being abnormal. Being abnormal for such an abnormal sensing data hold duration is likely to affect the operation to the device. In step 223, when the abnormal sensing data hold duration has reached the set duration, the monitoring chip utilizes the last sensing data received in the plurality of abnormal sensing data to update the recorded data of the monitoring chip, and provides an indication that the sensed object is operating abnormally. Abnormal sensing data can be provided to the device administrator to perform tracking or necessary correction actions to the abnormal internal environment of the device. The abnormal sensing data can also activate the self-protection mechanism of the device to prevent the abnormal internal environment from damaging the device.

In an embodiment of the present invention, the sensing data may be stored in the monitoring chip since it is normal data. Such sensing data can be utilized as reference data for calculating a data difference between subsequent sensing data. Hence, after sensing data is transmitted to the monitoring chip, the monitoring chip performs a calculation with respect to the sensing data and the previous sensing data to obtain a data difference. If the data difference has not reached the predetermined abnormal range, this indicates that the sensing data is normal and the monitoring chip can be updated according to the normal sensing data. In step 210, when a difference between the received sensing data the monitoring chip received from the sensor and the recorded data the monitoring chip recorded has not reached the predetermined abnormal range, the sensing data is utilized to update the recorded data of the monitoring chip.

In an embodiment of the present invention, the monitoring chip of the filtration method can be a baseboard management controller (BMC). The baseboard management controller can be included in an intelligent platform management interface (IPMI). The BMC can be a main controller in the IPMI and exchanges signals with other system module controllers (e.g., a south bridge, hardware monitor, power supply, sensor, chipset, peripheral interconnection slot, etc.) in the IPMI, so as to monitor and record data of other system module controllers in the IPMI. The BMC is able to control power up and power down of the device (e.g., a server).

In an embodiment of the present invention, the sensor of the filtration method can be a temperature sensor which senses a temperature of a sensed object. The temperature sensor can be electrically connected to the sensed object to detect the temperature of the sensed object. Alternatively, the temperature sensor can be integrated as hardware or firmware in the sensed object.

In an embodiment of the present invention, the sensed object of the filtration method can be a power controller, such as a power controller providing power to the device, or a power controller of a power supply module, etc.

In an embodiment of the present invention, the temperature sensor is electrically connected to the monitoring chip, such that the monitoring chip updates in real-time a temperature of a power controller sensed by the temperature sensor. For instance, the monitoring chip receives temperature sensing data of the power controller sensed in real-time by the temperature sensor in intervals of one second. The monitoring chip calculates a data difference between the current temperature sensing data and the temperature sensing data received one second ago to thereby determine whether the data difference has reached an abnormal range. The abnormal range can be, for instance, preset to 10 Celsius degrees (CC). Under normal circumstances, the temperature of a stable power supply should not differ by 10° C. in one second. If the data difference between the current temperature sensing data and the temperature sensing data received one second ago is less than 10° C., the monitoring chip updates according to the current temperature sensing data. If the data difference between the current temperature sensing data and the temperature sensing data received one second ago is more than 10° C., the temperature sensing data received one second ago is kept as the recorded data and the monitoring chip is temporarily considered to receive normal temperature sensing data same as the temperature sensing data received one second ago so that the sensed object (power controller) is temporarily considered to work normally.

The monitoring chip continues to monitor a plurality of temperature sensing data received after one second or after a number of seconds. The monitoring chip calculates data differences between the normal temperature sensing data and the plurality of temperature sensing data received after one second or after a number of seconds. If the hold duration of the data differences continuously exceeding the abnormal range has not reached a set duration (e.g., the set duration can be preset to 10 seconds) the monitoring chip treats the abnormal temperature variation of the power controller as temporary. The monitoring chip can delete the temperature sensing data and the plurality of temperature sensing data received after one second or after a number of seconds, and keeps the normal temperature sensing data as the recorded data.

However, if the hold duration of the data differences continuously exceeding the abnormal range has reached 10 seconds, the monitoring chip updates the last temperature sensing data in the plurality of abnormal sensing data received to the recorded data of the monitoring chip, and provides an indication that the power controller is operating abnormally.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A filtration method for filtrating abnormal sensing data by a monitoring chip, sensing data being obtained by a sensor sensing a sensed object in real-time, the monitoring chip receiving the sensing data from the sensor every detection period, the filtration method comprising:
when a duration of the monitoring chip continuously receiving a plurality of abnormal sensing data has reached a set duration, utilizing a last received sensing data in the plurality of abnormal sensing data and providing an indication that the sensed object is abnormal; and
when the duration of the monitoring chip continuously receiving the plurality of abnormal sensing data has not reached the set duration, utilizing a last received sensing data before receiving the plurality of abnormal sensing data without utilizing the plurality of abnormal sensing data.

2. The filtration method of claim 1, wherein the monitoring chip records recorded data corresponding to the sensor, and the recorded data is updated according to the sensing data.

3. The filtration method of claim 2, wherein utilizing the last received sensing data in the plurality of abnormal sensing data comprises utilizing the last received sensing data in the plurality of abnormal sensing data to update the recorded data.

4. The filtration method of claim 2, wherein utilizing the last received sensing data before receiving the plurality of abnormal sensing data comprises utilizing the last received sensing data before receiving the plurality of abnormal sensing data to be the recorded data.

5. The filtration method of claim 2, wherein when a difference between the sensing data the monitoring chip received from the sensor and the recorded data the monitoring chip recorded reaches a predetermined abnormal range, the sensing data is considered to be abnormal sensing data.

6. The filtration method of claim 5, wherein when the difference between the sensing data the monitoring chip received from the sensor and the recorded data the monitoring chip recorded does not reach the predetermined abnormal range, the sensing data is utilized to update the recorded data.

7. The filtration method of claim 1, wherein the monitoring chip is a baseboard management controller (BMC).

8. The filtration method of claim 1, wherein the sensor is a temperature sensor for sensing a temperature of the sensed object.

9. The filtration method of claim 8, wherein the temperature sensor is electrically connected to the monitoring chip.

10. The filtration method of claim 1, wherein the sensed object is a power controller.
